(19) United States
(12) Patent Application Publication
(10) Pub. No.: US 2025/0147498 A1
(43) Pub. Date: May 8, 2025

(54) INFORMATION PROCESSING METHOD, INFORMATION PROCESSING SYSTEM, AND RECORDING MEDIUM

(71) Applicants: Tokyo Electron Limited, Tokyo (JP); University of Tsukuba, Ibaraki (JP)

(72) Inventors: Jun TAMURA, Miyagi (JP); Tsuyoshi MORIYA, Tokyo (JP); Yuki KATAOKA, Sapporo City (JP); Akira IMAKURA, Ibaraki (JP); Tetsuya SAKURAI, Ibaraki (JP); Yasunori FUTAMURA, Ibaraki (JP); Xiucai YE, Ibaraki (JP)

(73) Assignees: Tokyo Electron Limited, Tokyo (JP); University of Tsukuba, Ibaraki (JP)

(21) Appl. No.: 19/016,213

(22) Filed: Jan. 10, 2025

Related U.S. Application Data
(63) Continuation of application No. PCT/JP2023/023072, filed on Jun. 22, 2023.

(30) Foreign Application Priority Data
Jul. 14, 2022 (JP) 2022-113348

(51) Int. Cl. G05B 19/418

(52) U.S. Cl. CPC G05B 19/41885; G05B 19/41845; G05B 2219/45031

(57) ABSTRACT

An information processing method, an information processing system, and a recording medium are provided. A computer executes processing of: acquiring, from apparatuses, first intermediate representations obtained by applying an intermediate representation conversion function to first data individually used by the apparatuses, acquiring, from the apparatuses, second intermediate representations obtained by applying the intermediate representation conversion function to second data commonly used by the apparatuses, adjusting parameters of an integrated representation conversion function to minimize a difference in integrated representations obtained by applying the integrated representation conversion function to the second intermediate representations acquired from the apparatuses, and deriving an apparatus difference correction function for correcting an apparatus difference between the apparatuses based on each of the first intermediate representations acquired from the apparatuses and the integrated representation conversion function for which the parameters are adjusted.

### CROSS-REFERENCE TO RELATED APPLICATIONS

This application is a bypass continuation application of international application No. PCT/JP2023/023072 having an international filing date of Jun. 22, 2023, and designating the United States, the international application being based upon and claiming the benefit of priority from Japanese Patent Application No. 2022-113348, filed on Jul. 14, 2022, the entire contents of each are incorporated herein by reference.

### TECHNICAL FIELD

The present invention relates to an information processing method, an information processing system, and a recording medium.

### BACKGROUND

The transfer of data obtained from certain types of apparatuses across facilities is restricted from the standpoint of confidentiality. In this case, the analysis of the data obtained from the apparatus is performed individually in each facility. For example, the correction of apparatus differences between the apparatuses is performed in a facility where a plurality of apparatuses are operated. Further, when some prediction model is required for the apparatus, prediction models are individually constructed in the facilities using only data obtained by the facilities.

### CITATION LIST

### Patent Documents

Patent Document 1: JP-A-2019-165123

### SUMMARY

An object of the present disclosure is to provide an information processing method, an information processing system, and a recording medium, which can correct an apparatus difference and construct a prediction model by collecting data in a confidential state referred to as an intermediate representation from a plurality of apparatuses.

The information processing method of the present disclosure causes a computer to execute processing of: acquiring, from apparatuses, first intermediate representations obtained by applying an intermediate representation conversion function to first data individually used by the apparatuses, acquiring, from the apparatuses, second intermediate representations obtained by applying the intermediate representation conversion function to second data commonly used by the apparatuses, adjusting parameters of an integrated representation conversion function to minimize a difference in integrated representations obtained by applying the integrated representation conversion function to the second intermediate representations acquired from the apparatuses, and deriving an apparatus difference correction function for correcting an apparatus difference between the apparatuses based on each of the first intermediate representations acquired from the apparatuses and the integrated representation conversion function for which the parameters are adjusted.

According to the present disclosure, an apparatus difference can be corrected and a prediction model can be constructed by collecting data in a confidential state referred to as an intermediate representation from a plurality of apparatuses.

### BRIEF DESCRIPTION OF DRAWINGS

FIG. 1 is a schematic diagram showing a configuration example of an information processing system according to an embodiment.

FIG. 2 is a block diagram showing an internal configuration of an operation facility server.

FIG. 3 is a block diagram showing an internal configuration of an analysis facility server.

FIG. 4 is an illustration view illustrating an outline of processing in a training phase.

FIG. 5 is a flowchart showing a procedure of performing processing in the training phase.

FIG. 6 is a flowchart showing a procedure of performing processing in an operation phase.

FIG. 7 is a flowchart showing a procedure of processing executed by the analysis facility server according to Embodiment 2.

### DETAILED DESCRIPTION

Hereinafter, an embodiment will be described with reference to the drawings.

### Embodiment 1

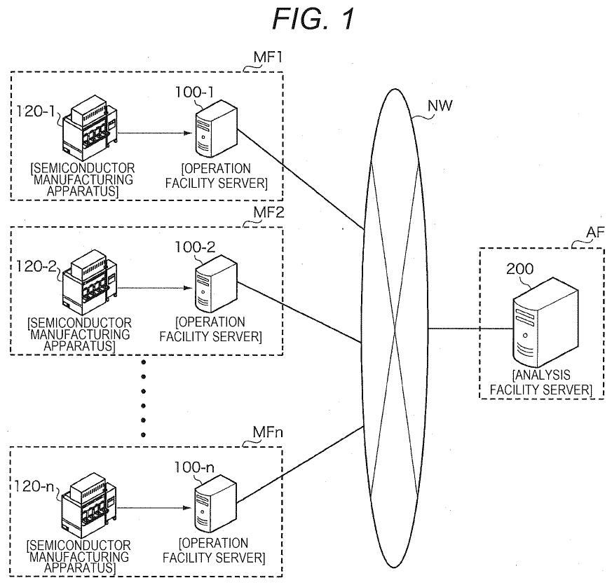

FIG. 1 is a schematic diagram showing a configuration example of an information processing system according to an embodiment. The information processing system according to the embodiment includes a plurality of operation facility servers 100-1, 100-2, . . . , 100-n respectively disposed in a plurality of apparatus operation facilities MF1, MF2, . . . , MFn, and an analysis facility server 200 disposed in an analysis facility AF. n is an integer of 2 or more. The operation facility servers 100-1, 100-2, . . . , 100-n are communicably connected to the analysis facility server 200 via a communication network NW.

The operation facility server 100-1 is a server apparatus disposed in the apparatus operation facility MF1. An apparatus 120-1 is operated in the apparatus operation facility MF1. In the example shown in FIG. 1, only one apparatus 120-1 is illustrated for the sake of simplicity. Alternatively, the number of apparatuses operated in the apparatus operation facility MF1 may be two or more. An example of the apparatus operation facility MF1 is a semiconductor manufacturer, and an example of the apparatus 120-1 is a semiconductor manufacturing apparatus.

The operation facility server 100-1 holds data (first data) individually used by the apparatus 120-1, and data (second data) commonly used by the plurality of apparatus operation facilities MF1 to MFn. In the following description, the data individually used by the apparatus 120-1 will also be referred to as raw data, and the data commonly used by the facilities will also be referred to as anchor data.

The raw data may include confidential information that cannot be provided to another facility. When the apparatus 120-1 in the apparatus operation facility MF1 is a semiconductor manufacturing apparatus, the raw data includes at least one of substrate measurement result data before substrate processing, time series data during the substrate processing, and substrate measurement result data after the substrate processing.

The operation facility server 100-1 cannot provide the raw data as it is to the analysis facility server 200 from the viewpoint of confidentiality of information. Therefore, when the raw data is to be provided to the analysis facility server 200, the operation facility server 100-1 converts the raw data into an intermediate representation using an intermediate representation conversion function F₁ unique to the operation facility server 100-1 and provides the converted intermediate representation to the analysis facility server 200.

The operation facility server 100-1 converts the anchor data into an intermediate representation by using the same intermediate representation conversion function F₁ and provides the intermediate representation of the converted anchor data and the intermediate representation of the converted raw data to the analysis facility server 200. In the following description, the intermediate representation of the raw data will also be referred to as a raw data intermediate representation, and the intermediate representation of the anchor data will also be referred to as an anchor data intermediate representation.

The same applies to the other operation facility servers 100-2, . . . , 100-n. The operation facility server 100-i (i is an integer of 2 to n) holds raw data individually used by an apparatus 120-i and anchor data commonly used by the facilities. The operation facility server 100-i converts the raw data and the anchor data into respective intermediate representations by using a unique intermediate representation conversion function Fᵢ, and provides the intermediate representations to the analysis facility server 200.

The analysis facility server 200 is a server device provided in the analysis facility AF. The analysis facility server 200 acquires raw data intermediate representations and anchor data intermediate representations from the operation facility servers 100-1, 100-2, . . . , 100-n. The analysis facility server 200 generates an apparatus difference correction function and a prediction model based on the raw data intermediate representations acquired from the operation facility servers 100-1, 100-2, . . . , 100-n. The apparatus difference correction function is a function for correcting apparatus differences among the apparatuses 120-1, 120-2, . . . , 120-n, and can be derived based on the raw data intermediate representation. The prediction model is a model that outputs estimated values of response data for the apparatuses 120-1, 120-2, . . . , 120-n when raw data is input. The prediction model can be derived based on an apparatus difference correction function or a raw data intermediate representation. The analysis facility server 200 provides the generated apparatus difference correction functions and prediction models to the operation facility servers 100-1, 100-2, . . . , 100-n.

In the following description, when it is not necessary to distinguish among the operation facility servers 100-1, 100-2, . . . , 100-n, the operation facility servers 100-1, 100-2, . . . , 100-n will also be simply referred to as an operation facility server 100.

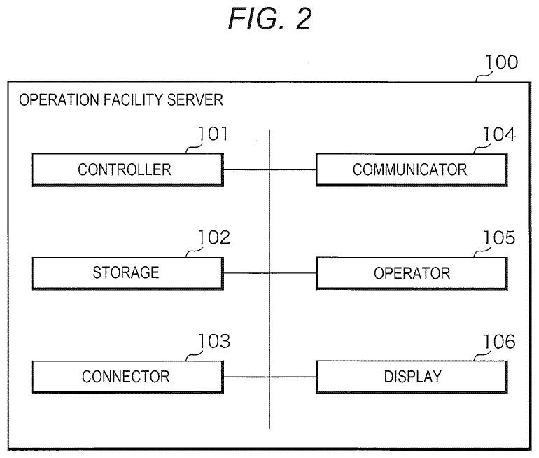

FIG. 2 is a block diagram showing an internal configuration of the operation facility server 100. The operation facility server 100 is a dedicated or general-purpose server and includes a controller 101, a storage 102, a connector 103, a communicator 104, an operator 105, and a display 106.

The controller 101 includes a central processing unit (CPU), a read only memory (ROM), a random access memory (RAM), and the like. The ROM provided in the controller 101 stores control programs and the like for controlling an operation of each component of a hardware provided in the operation facility server 100. The CPU in the controller 101 reads and executes control programs stored in the ROM and various types of computer programs stored in the storage 102, and controls the operation of each component of the hardware, and thus causes the entire apparatus to function as the operation facility server 100 of the present disclosure. The RAM provided in the controller 101 temporarily stores data used during the execution of an arithmetic operation.

In the embodiment, although the controller 101 includes the CPU, the ROM, and the RAM, the configuration of the controller 101 is not limited to the above-described configuration. The controller 101 may be, for example, one or a plurality of control circuits or arithmetic circuits that include a graphics processing unit (GPU), a field programmable gate array (FPGA), a digital signal processor (DSP), a quantum processor, a volatile or nonvolatile memory, or the like. In addition, the controller 101 may include functions such as a clock for outputting date and time information, a timer for measuring the time elapsed from the time when a measurement start instruction is applied to the time when a measurement end instruction is applied, and a counter for counting the number.

The storage 102 includes storage devices such as a hard disk drive (HDD), a solid state drive (SSD), and an electronically erasable programmable read only memory (EEPROM). The storage 102 stores various types of computer programs executed by the controller 101 and various data used by the controller 101.

The connector 103 includes a connection interface for connecting the apparatus 120-1 (or 120-2 to 120-n). The connection interface may be a wired interface or a wireless interface. The operation facility server 100 acquires raw data from the apparatus 120-1 connected to the connector 103.

The communicator 104 includes a communication interface for transmitting and receiving various types of data to and from an external apparatus including the analysis facility server 200. As the communication interface provided in the communicator 104, for example, a communication interface conforming to a communication standard such as a local area network (LAN) can be used. When data to be transmitted is input from the controller 101, the communicator 104 transmits the data to the external apparatus that is a destination, and outputs received data to the controller 101 when the data transmitted from the external apparatus is received.

The operator 105 includes operating devices such as a touch panel, a keyboard, and switches, and receives various types of operations and settings by the user or the like. The controller 101 performs appropriate controls based on various operation information supplied by the operator 105, and causes the storage 102 to store setting information as necessary.

The display 106 includes a display device such as a liquid crystal monitor or an organic electro-luminescence (EL), and displays information to be notified to the user or the like in response to an instruction from the controller 101.

The operation facility server 100 in the present embodiment may be a single server, or may be a server system including a plurality of servers, peripheral devices, and the like. In addition, the operation facility server 100 may be a virtual machine in which entities are virtualized, or may be a cloud. Further, the operation facility server 100 may be provided in each of the apparatuses 120-1, 120-2, . . . , 120-n.

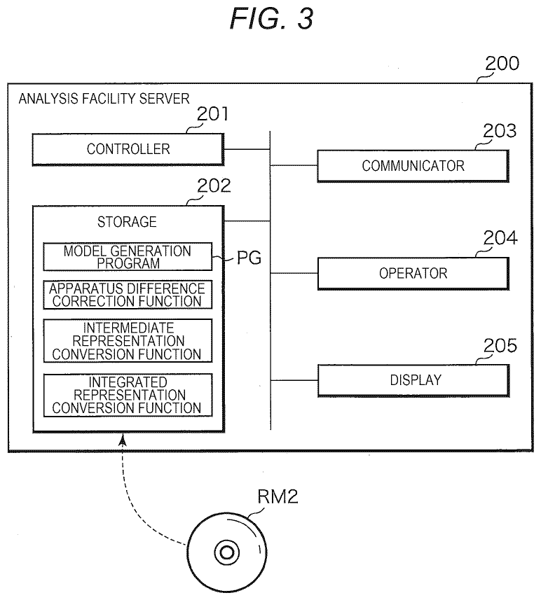

FIG. 3 is a block diagram showing an internal configuration of the analysis facility server 200. The analysis facility server 200 is a dedicated or general-purpose server and includes a controller 201, a storage 202, a communicator 203, an operator 204, and a display 205.

The controller 201 includes a CPU, a ROM, a RAM, and the like. The ROM provided in the controller 201 stores control programs and the like for controlling the operation of each component of the hardware provided in the analysis facility server 200. The CPU in the controller 201 reads and executes control programs stored in the ROM and various types of computer programs stored in the storage 202, and controls the operation of each component of the hardware, and thus causes the entire apparatus to function as the analysis facility server 200 of the present disclosure. The RAM provided in the controller 201 temporarily stores data used during the execution of an arithmetic operation.

In the embodiment, although the controller 201 includes the CPU, the ROM, and the RAM, the configuration of the controller 201 is not limited to the above-described configuration. The controller 201 may be, for example, one or a plurality of control circuits or arithmetic circuits that include a GPU, an FPGA, a DSP, a quantum processor, a volatile or nonvolatile memory, or the like. In addition, the controller 201 may include functions such as a clock for outputting date and time information, a timer for measuring the time elapsed from the time when a measurement start instruction is applied to the time when a measurement end instruction is applied, and a counter for counting the number.

The storage 202 includes storage devices such as an HDD, an SSD, and an EEPROM. The storage 202 stores various types of computer programs executed by the controller 201 and various data used by the controller 201.

The computer program stored in the storage 202 includes a model generation program PG (program product) that causes the analysis facility server 200 to execute processing for generating an apparatus difference correction function, an intermediate representation conversion function, an integrated representation conversion function, a prediction model, or the like to be described below. For the data stored in the storage 202, the data (parameter) of the apparatus difference correction function, the intermediate representation conversion function, the integrated representation conversion function, and the prediction model, which are generated by the model generation program PG, is stored. Further, the storage 202 stores data (such as intermediate representations of explanatory variables, response variables, and intermediate representations of anchor data) transmitted from the operation facility server 100.

The computer program stored in the storage 202 is provided by a non-temporary recording medium RM2 on which the computer program is recorded in a readable manner. The recording medium RM2 is a portable memory such as a CD-ROM, a USB memory, a secure digital (SD) card, a micro SD card, or a compact flash (registered trademark). The controller 201 reads various types of computer programs from the recording medium RM2 using a reading device (not illustrated) and stores the read various types of computer programs in the storage 202. In addition, the computer program stored in the storage 202 may be provided through communication. In this case, the controller 201 may acquire the computer program through communication via the communicator 203, and may store the acquired computer program in the storage 202.

The communicator 203 includes a communication interface for transmitting and receiving various types of data to and from an external apparatus including the operation facility server 100. As the communication interface provided in the communicator 203, for example, a communication interface conforming to a communication standard such as a LAN can be used. When data to be transmitted is input from the controller 201, the communicator 203 transmits the data to the external apparatus that is a destination, and outputs the received data to the controller 201 when the data transmitted from the external apparatus is received.

The operator 204 includes operating devices such as a touch panel, a keyboard, and switches, and receives various types of operations and settings by the user or the like. The controller 201 performs appropriate controls based on various operation information supplied by the operator 204, and causes the storage 202 to store setting information as necessary.

The display 205 includes a display device such as a liquid crystal monitor or an organic electro-luminescence (EL), and displays information to be notified to the user or the like in response to an instruction from the controller 201.

The analysis facility server 200 in the present embodiment may be a single server, or may be a server system including a plurality of servers, peripheral devices, or the like. In addition, the analysis facility server 200 may be a virtual machine in which entities are virtualized, or may be a cloud.

The information processing system according to the embodiment generates an apparatus difference correction function or a prediction model in a training phase before the start of an operation, and estimates response data using the prediction model in an operation phase after the start of the operation.

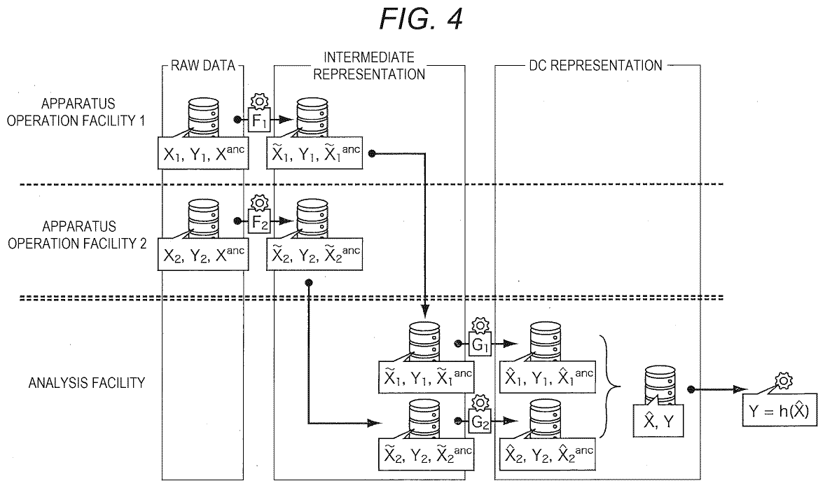

FIG. 4 is an illustration view illustrating an outline of processing in a training phase. In FIG. 4, for the sake of simplicity, the number of apparatus operation facilities is two. The apparatus operation facility MF1 is referred to as [apparatus operation facility 1], and the apparatus operation facility MF2 is referred to as [apparatus operation facility 2]. While the apparatus 120-1 is operating in the apparatus operation facility MF1, raw data is obtained from the apparatus 120-1. The raw data includes explanatory variables and response variables. For example, when the apparatus 120-1 is a semiconductor manufacturing apparatus, the explanatory variables include the cumulative usage time, the power source voltage, the temperature, the pressure, and the like, and the response variables include the component consumption degree, and the like. In FIG. 4, the explanatory variable obtained by the apparatus operation facility MF1 is denoted by X₁, and the response variable is denoted by Y₁. Raw data that includes the explanatory variable X₁ and the response variable Y₁ is collected at any time during the training phase and stored in the storage 102 of the operation facility server 100-1.

The same applies to the apparatus operation facility MF2. In the training phase, the storage 102 of the operation facility server 100-2 stores raw data (an explanatory variable X₂ and a response variable Y₂) obtained during the operation of the apparatus 120-2.

The X^{anc} in the drawing is anchor data shared by the apparatus operation facilities MF1 and MF2. The anchor data X^{anc} is generated by the apparatus operation facilities MF1 and MF2 using the same random seeds such that the anchor data X^{anc} has the same dimensionality as the explanatory variables and has at least about 1000 records.

The operation facility servers 100-1 and 100-2 are provided with intermediate representation conversion functions F₁ and F₂, respectively. The intermediate representation conversion functions F₁ and F₂ are functions respectively provided in the operation facility servers 100-1 and 100-2, and may be, for example, principal component conversion functions in principal component analysis.

When the raw data and the anchor data are to be transmitted to the analysis facility server 200, the operation facility servers 100-1 and 100-2 convert the raw data and the anchor data into intermediate representations using the intermediate representation conversion functions F₁ and F₂, respectively. In the present embodiment, an explanatory variable among the raw data is converted into an intermediate representation, and a response variable is not converted into an intermediate representation. In the drawings, intermediate representations obtained by applying the intermediate representation conversion function F₁ to the explanatory variables X₁ and the anchor data X^{anc} are referred to as X₁_tilde and X₁^{anc}_tilde. Intermediate representations obtained by applying the intermediate representation conversion function F₂ to the explanatory variables X₂ and the anchor data X^{anc} are denoted by X₂_tilde and X₂^{anc}_tilde. In the specification, . . . _ tilde represents a character with a tilde.

The analysis facility server 200 receives the intermediate representation X₁_tilde of the explanatory variable X₁, the response variable Y₁, and the intermediate representation X₁^{anc}_tilde of the anchor data X^{anc} transmitted from the operation facility server 100-1, and stores them in the storage 202. Similarly, the analysis facility server 200 receives the intermediate representation X₂_tilde of the explanatory variable X₂, the response variable Y₂, and the intermediate representation X₂^{anc}_tilde of the anchor data X^{anc} transmitted from the operation facility server 100-2, and stores them in the storage 202.

The analysis facility servers 200 is provided with integrated representation conversion functions G₁ and G₂ for each apparatus operation facility. The integrated representation conversion functions G₁ and G₂ are functions generated by applying the integrated representation conversion functions G₁ and G₂ to the intermediate representations X₁^{anc}_tilde and X₂^{anc}_tilde of the anchor data X^{anc} acquired from the operation facility servers 100-1 and 100-2, respectively, and adjusting the parameters of the integrated representation conversion functions G₁ and G₂ so as to minimize the difference between the obtained integrated representations. The analysis facility server 200 respectively converts the intermediate representation X₁_tilde of the explanatory variable and the intermediate representation X₁^{anc}_tilde of the anchor data into integrated representations by using the integrated representation conversion function G₁ for the apparatus operation facility MF1. The integrated representations after the conversion are denoted by X₁_hat and X₁^{anc}_hat, respectively. The analysis facility server 200 respectively converts the intermediate representation X₂_tilde of the explanatory variable and the intermediate representation X₂^{anc}_tilde of the anchor data into integrated representations by using the integrated representation conversion function G₂ for the apparatus operation facility MF2. The integrated representations after the conversion are denoted by X₂_hat and X₂^{anc}_hat, respectively. The integrated representation is also referred to as a data collaboration (DC) representation. In the specification, . . . -hat represents a character with a hat.

The data individually used by each apparatus operation facility can be integrated as one piece of data by converting the data into an integrated representation in the analysis facility server 200. However, when there is an apparatus difference between the apparatuses (in this example, between the apparatuses 120-1 and 120-2), the analysis performance may deteriorate by integrating data having an apparatus difference. Therefore, the analysis facility server 200 according to the present embodiment derives an apparatus difference correction function for correcting apparatus differences between apparatuses by using the integrated representations X₁_hat and X₂_hat of raw data (explanatory variables) generated by the apparatus operation facilities.

The analysis facility server 200 sets, based on the integrated data, a problem of classifying original facilities and derives a correction function by finding an apparatus difference correction value that makes it difficult to classify the original facilities properly. The explanatory variables of the raw data are assumed to be multivariate normal distributed, and the differences in variance-covariance are corrected by a rotation matrix (including a scale), and differences in the means are corrected by a shift. The classification problem can be represented by Math. 1.

$${max}_{D , S} {min}_{W} ‖ [ \begin{matrix}1 \\ - 1\end{matrix} ] - [ \begin{matrix}( {X}_{1} {F}_{1} ) {G}_{1} \\ ( ( {X}_{2} {D}^{- 1} + S ) {F}_{2} ) {G}_{2}\end{matrix} ] W ‖ \qquad [ Math . 1 ]$$

Here, the apparatus operation facility MF1 is a reference facility, and the apparatus operation facility MF2 is a target facility for apparatus difference correction. Matrices X, F, and G in Math. 1 respectively represent explanatory variables of raw data, an intermediate representation conversion function, and an integrated representation conversion function for each facility, and subscripts represent facility numbers. Matrices D and S in Math. 1 are a rotation matrix and a shift matrix, respectively, and are applied to the raw data of the apparatus operation facility MF2 to correct the shift apparatus difference and the variance-covariance apparatus difference. W is a classifier. The analysis facility server 200 calculates a classification error by solving the classification problem using integrated data of the apparatus operation facility MF1 as a positive example and integrated data of the apparatus operation facility MF2 after the apparatus difference correction as a negative example. The analysis facility server 200 estimates the apparatus difference by optimizing the matrices D and S for which the classification error is the largest using the quasi-Newton method.

When this method is applied to the DC analysis, the matrices D and S to be optimized is required to be taken outside the intermediate representation, and thus the matrices are decomposed as shown in Math. 2.

$${max}_{{α}_{1} , … , {α}_{s} , {β}_{1} , … , {β}_{s}} {min}_{W} ‖ [ \begin{matrix}1 \\ - 1\end{matrix} ] - [ \begin{matrix}( {X}_{1} {F}_{1} ) {G}_{1} \\ ( {X}_{2} {\sum }_{i = 1}^{s} {α}_{i} {D}_{i} {F}_{2} ) {G}_{2} + ( {\sum }_{i = 1}^{s} {β}_{i} {S}_{i} {F}_{2} ) {G}_{2}\end{matrix} ] W ‖ \qquad [ Math . 2 ]$$

When the number of explanatory variables is s, the rotation matrix D can be expressed as a linear combination of s rotation matrices, and a coefficient matrix αᵢ for a rotation matrix Dᵢ is the apparatus difference of variance-covariance included in the i-th explanatory variable. Similarly, the shift matrix S can be represented as a linear combination of s diagonal matrices with orthogonal basis vectors as diagonal elements, and a coefficients βᵢ for a diagonal matrix Si is a shift apparatus difference included in the i-th explanatory variable.

$${max}_{{α}_{1} , … , {α}_{s} , {β}_{1} , … , {β}_{s}} {min}_{W} ‖ [ \begin{matrix}1 \\ - 1\end{matrix} ] - [ \begin{matrix}( {X}_{1} {F}_{1} ) {G}_{1} \\ {\sum }_{i = 1}^{s} {α}_{i} ( {X}_{2} {D}_{i} {F}_{2} ) {G}_{2} + {\sum }_{i = 1}^{s} {β}_{i} ( {S}_{i} {F}_{2} ) {G}_{2}\end{matrix} ] W ‖ \qquad [ Math . 3 ]$$

In this way, αᵢ and βᵢ can be taken outside the intermediate representation as shown in Math. 3, and thus the apparatus difference correction functions can be generated by the analysis facility AF without sharing the raw data. Further, integrated analysis in which the influence of the apparatus difference is removed can be implemented by applying the correction function to the intermediate representation and converting the intermediate representation into integrated data.

The analysis facility server 200 can generate, by integrating the data after applying the apparatus difference correction function, training data in which the explanatory variable X_hat independent of the apparatus is combined with the corresponding response variable Y.

The analysis facility server 200 uses the training data including the explanatory variable X_hat and the response variable Y to generate a prediction model that predicts the response variable Y (response data) based on the explanatory variable X. In FIG. 4, Y=h(X_hat) represents a prediction model that outputs an estimated value of a response variable when an explanatory variable (integrated representation) is input. The analysis facility server 200 can generate a prediction model by using a known method such as linear regression. Alternatively, the analysis facility server 200 may generate a prediction model using other machine learning algorithms such as a support vector machine, a random forest, or a neural network.

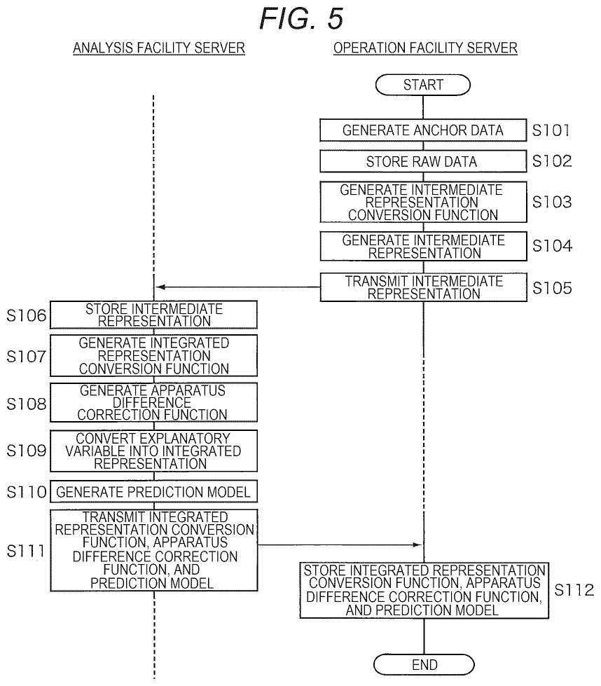

FIG. 5 is a flowchart showing a procedure of performing processing in the training phase. The controller 101 of the operation facility server 100 generates anchor data common to the apparatus operation facilities MF1 to MFn, and stores the generated anchor data in the storage 102 (step S101). The controller 101 can generate the anchor data common to the apparatus operation facilities MF1 to MFn by using the same random seed by the apparatus operation facilities MF1 to MFn.

The controller 101 causes the storage 102 to store raw data (i.e., explanatory variables and response variables) obtained during the operation of the apparatuses (step S102), and generates an intermediate representation conversion function based on the anchor data and the explanatory variables (step $103). For example, the controller 101 may generate a principal component conversion function in the principal component analysis as the intermediate representation conversion function.

The controller 101 generates intermediate representations of the explanatory variables and the anchor data (step S104) and transmits the training data (the intermediate representations of the explanatory variables and the response variable) and the intermediate representation of the anchor data from the communicator 104 to the analysis facility server 200 (step S105).

The controller 201 of the analysis facility server 200 receives the training data and the intermediate representation of the anchor data through the communicator 203 and causes the storage 202 to store these pieces of data (step S106). The analysis facility server 200 collects the training data until the collection period elapses or the number of pieces of collected data exceeds a predetermined number.

The controller 201 generates an integrated representation conversion function based on the intermediate representation of the anchor data (step S107). The controller 201 can generate an integrated representation conversion function for each facility by applying an integrated representation conversion function for each facility to anchor data intermediate representations of each of the apparatus operation facilities MF1 to MFn, and adjusting parameters of the integrated representation function for each facility so as to minimize the difference between the obtained integrated representations.

The controller 201 generates an apparatus difference correction function from the intermediate representations of the explanatory variables included in the training data (step S108). The controller 201 can derive the apparatus difference correction function by using the intermediate representations of the explanatory variables as shown in Math. 3.

The controller 201 applies the integrated representation conversion function and the apparatus difference correction function to the intermediate representations of the explanatory variables included in the training data, thereby converting the intermediate representations into an integrated representation (step S109). The controller 201 generates a prediction model using the integrated representation (explanatory variables) after the conversion and the response variables included in the training data (step S110). For example, linear regression can be used to generate the prediction model, and other machine learning algorithms may be used.

The controller 201 transmits the generated integrated representation conversion function, the generated apparatus difference correction function, and the generated prediction model to each operation facility server 100 through the communicator 203 (step S111).

The controller 101 of the operation facility server 100 receives the integrated representation conversion function, the apparatus difference correction function, and the prediction model transmitted from the analysis facility server 200, and stores these in the storage 102 (step S112).

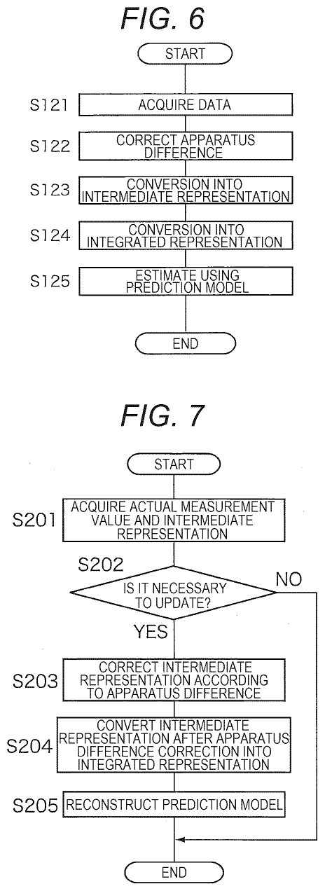

FIG. 6 is a flowchart showing a procedure of performing processing in the operation phase. The controller 101 of the operation facility server 100 acquires data (i.e., explanatory variables and response variables) obtained during the operation of the apparatuses (step S121).

The controller 101 successively applies the apparatus difference correction function, the intermediate representation conversion function, and the integrated representation conversion function to the explanatory variables included in the acquired data to execute the apparatus difference correction, the conversion into the intermediate representation, and the conversion into the integrated representation (steps S122 to S124).

The controller 101 inputs the integrated representation obtained in step S124 into the prediction model, thereby estimating the response data of the apparatuses (step S125). The controller 101 causes the display 106 to display the estimated response data. Alternatively, the controller 101 may output the estimated response data to the communicator 104, and transmit the estimated response data to a user terminal (not shown) through the communicator 104.

As described above, in Embodiment 1, the integrated representation conversion function is generated by using the intermediate representation of the anchor data commonly used by a plurality of apparatuses. Further, in Embodiment 1, the apparatus difference correction function for correcting the apparatus difference between apparatuses or the prediction model for estimating response data of apparatuses is generated by performing an analysis by applying the integrated representation conversion function to the intermediate representations of raw data individually used by a plurality of apparatuses. In the present embodiment, even when data is collected in the state of the intermediate representation, the apparatus difference correction function or the prediction model can be generated. Apparatus differences of all the apparatuses at, for example, a shipping source of the apparatuses can be understood and corrected, and thus improvements can be expected in terms of quality control.

### Embodiment 2

In Embodiment 2, the update of the prediction model will be described.

FIG. 7 is a flowchart showing a procedure of processing executed by the analysis facility server 200 according to Embodiment 2. The controller 201 of the analysis facility server 200 acquires actual measurement values (response variables) and intermediate representations (explanatory variables) obtained during the operation of the apparatus by the apparatus operation facilities MF1 to MFn (step S201). The obtained actual measurement values and intermediate representations are stored as a set in the storage 202.

The controller 201 determines whether an update of the prediction model is necessary (step S202). The controller 201 may calculate the degree of deviation between the obtained actual measurement value (response variable) and the response data (predicted value) obtained by inputting the obtained intermediate representation (explanatory variable) into the prediction model, and determine to update the prediction model when the calculated degree of deviation is equal to or more than a threshold value. When it is determined that the update is not necessary (S202: NO), the controller 201 ends the processing according to the present flowchart.

When it is determined that the update is necessary (S202: YES), the controller 201 corrects the intermediate representation (explanatory variable) stored in the storage 202 by the apparatus difference correction function (step S203), and converts the intermediate representation after the apparatus difference correction into an integrated representation by the integrated representation conversion function (step S204).

The controller 201 reconstructs the prediction model by using a set of the explanatory variable converted into the integrated representation and the corresponding actual measurement value (response variable) (step S205). Known techniques such as linear regression are used for the reconstruction of the prediction model. Alternatively, the prediction model may be reconstructed using other machine learning algorithms such as a support vector machine, a random forest, or a neural network.

As described above, in Embodiment 2, the prediction model can be reconstructed when the actual measurement values for the apparatuses deviate from the predicted values obtained by the prediction model.

The features described in each embodiment can be combined with each other. In addition, the independent and dependent claims set forth in the claims can be combined with each other in any and all combinations, regardless of the reciting format. Furthermore, the claims do not use a format of describing claims that recite two or more other claims (multi-claim format). The claims may also be described using a format of multi-claims or a format of multi-claims reciting at least one multi-claim (multi-multi claims).

The embodiments disclosed herein are exemplary in all respects and are required to be considered to be not restrictive embodiments. The scope of the present invention is indicated by the scope of the aspects, not the meaning described above, and is intended to include meanings equivalent to the scope of the aspects and all changes within the scope.

For example, in the present embodiment, semiconductor manufacturers have been given as an example of the apparatus operation facilities MF1 to MFn, and semiconductor manufacturing apparatuses have been given as examples of the apparatuses 120-1 to 120-n, but the present invention is not limited to these examples. The apparatus operation facilities MF1 to MFn may be medical facilities or financial facilities, and the apparatuses 120-1 to 120-n may be medical devices or terminals used in these facilities.

1. An information processing method of causing a computer to execute processing of:
acquiring, from apparatuses, first intermediate representations obtained by applying an intermediate representation conversion function to first data individually used by the apparatuses,
acquiring, from the apparatuses, second intermediate representations obtained by applying the intermediate representation conversion function to second data commonly used by the apparatuses,
adjusting parameters of an integrated representation conversion function to minimize a difference in integrated representations obtained by applying the integrated representation conversion function to the second intermediate representations acquired from the apparatuses, and
deriving an apparatus difference correction function for correcting an apparatus difference between the apparatuses based on each of the first intermediate representations acquired from the apparatuses and the integrated representation conversion function for which the parameters are adjusted.

2. The information processing method according to claim 1, further comprising:
using the integrated representations to set a classification problem for classifying the apparatuses, and
deriving an apparatus difference correction function to maximize a classification error obtained by solving the set classification problem.

3. The information processing method according to claim 1, wherein
the apparatus difference correction function is described by a shift matrix for correcting a difference in averages between the first data, and a rotation matrix for correcting a difference in variance-covariance between the first data, and
the shift matrix and the rotation matrix are described as a linear combination of coefficient matrices and a linear combination of diagonal matrices, respectively, and the coefficient matrix is taken outside the first intermediate representation and optimized to derive the apparatus difference correction function.

4. The information processing method according to claim 1, further comprising:
acquiring response data output from the apparatuses in response to input of the first data, and
generating a prediction model for outputting a predicted value of the response data when inputting, by using an integrated representation after apparatus difference correction for the first data and the acquired response data as training data, the integrated representation after the apparatus difference correction.

5. The information processing method according to claim 4, further comprising:
determining necessity of update of the prediction model in accordance with a degree of deviation between the response data obtained from the apparatuses and the predicted value obtained by the prediction model, and
updating the prediction model when determining that update is necessary.

6. The information processing method according to claim 1, wherein
the apparatus is a semiconductor manufacturing apparatus.

7. The information processing method according to claim 6, wherein
the first data includes at least one of substrate measurement result data before substrate processing, time series data during the substrate processing, and substrate measurement result data after the substrate processing.

8. The information processing method according to claim 6, wherein
the apparatus difference as a correction target includes at least one of an apparatus difference relating to substrate measurement in the semiconductor manufacturing apparatus, an apparatus difference relating to a sensor provided in the semiconductor manufacturing apparatus, an apparatus difference between chambers provided in the semiconductor manufacturing apparatus, an apparatus difference between units including the semiconductor manufacturing apparatus, an apparatus difference relating to a change over time of the semiconductor manufacturing apparatus, and a difference between recipes used by the semiconductor manufacturing apparatus.

9. An information processing system comprising:
operation facility servers each including
a first intermediate representation generator configured to generate a first intermediate representation by applying an intermediate representation conversion function provided in the operation facility server to first data individually used by operation target apparatuses,
a second intermediate representation generator configured to generate a second intermediate representation by applying the intermediate representation conversion function to second data commonly used between the apparatuses, and
an output unit configured to output the generated first intermediate representation and second intermediate representation, and
an analysis facility server including
an intermediate representation acquisition unit configured to acquire the first intermediate representation and the second intermediate representation output from each operation facility server,
an integrated representation generator configured to generate an integrated representation by applying an integrated representation conversion function to each of the acquired second intermediate representations,
an adjustment unit configured to adjust a parameter of the integrated representation conversion function to minimize a difference in the generated integrated representations, and
a derivation unit configured to derive an apparatus difference correction function for correcting an apparatus difference among apparatuses based on each of the acquired first intermediate representations and the integrated representation conversion function for which the parameters are adjusted.

10. The information processing system according to claim 9, wherein
the operation facility server includes
a function acquisition unit configured to acquire the apparatus difference correction function derived by the analysis facility server, and
an apparatus difference correction unit configured to correct, based on the acquired apparatus difference correction function, an apparatus difference in the first data used by the operation target apparatus.

11. The information processing system according to claim 9, wherein
the analysis facility server further includes
a response data acquisition unit configured to acquire response data output from the apparatuses in response to input of the first data, and
a model generator configured to generate, when inputting the integrated representation after the apparatus difference correction, a prediction model for outputting a predicted value of the response data by using an integrated representation after apparatus difference correction for the first data and the acquired response data as training data.

12. The information processing system according to claim 11, wherein
the analysis facility server further includes
a determination unit configured to determine necessity of update of the prediction model in accordance with a degree of deviation between the response data obtained from the apparatuses and the predicted value obtained by the prediction model, and
an update unit configured to update the prediction model when determining that update is necessary.

13. The information processing system according to claim 9, wherein
the apparatus is a semiconductor manufacturing apparatus.

14. The information processing system according to claim 13, wherein
the first data includes at least one of substrate measurement result data before substrate processing, time series data during the substrate processing, and substrate measurement result data after the substrate processing.

15. The information processing system according to claim 13, wherein
the apparatus difference as a correction target includes at least one of an apparatus difference relating to substrate measurement in the semiconductor manufacturing apparatus, an apparatus difference relating to a sensor provided in the semiconductor manufacturing apparatus, an apparatus difference between chambers provided in the semiconductor manufacturing apparatus, an apparatus difference between units including the semiconductor manufacturing apparatus, an apparatus difference relating to a change over time of the semiconductor manufacturing apparatus, and a difference between recipes used by the semiconductor manufacturing apparatus.

16. A non-transitory computer readable recording medium storing a computer program for causing a computer to execute processing of:
acquiring, from apparatuses, first intermediate representations obtained by applying an intermediate representation conversion function to first data individually used by the apparatuses,
acquiring, from the apparatuses, second intermediate representations obtained by applying the intermediate representation conversion function to second data commonly used by the apparatuses,
adjusting parameters of an integrated representation conversion function to minimize a difference in integrated representations obtained by applying the integrated representation conversion function to the second intermediate representations acquired from the apparatuses, and
deriving an apparatus difference correction function for correcting an apparatus difference between the apparatuses based on each of the first intermediate representations acquired from the apparatuses and the integrated representation conversion function for which the parameters are adjusted.
